(19) United States
(12) Patent Application Publication
(10) Pub. No.: US 2026/0008417 A1
(43) Pub. Date: Jan. 8, 2026

(54) VEHICLE CABIN ASSEMBLY AND MOTOR VEHICLE

(71) Applicant: Dr. Ing. h.c. F. Porsche Aktiengesellschaft, Stuttgart (DE)

(72) Inventor: Thomas GROSCHOPF, Rutesheim (DE)

(21) Appl. No.: 19/256,192

(22) Filed: Jul. 1, 2025

(30) Foreign Application Priority Data
Jul. 4, 2024 (DE) 10 2024 119 015.9

(51) Int. Cl. B60R 7/10

(52) U.S. Cl. CPC B60R 7/10

(57) ABSTRACT

A vehicle cabin assembly includes a self-presenting cabin functional part configured to be moved from a passive position into an active position in a vehicle cabin using a guiding device combined with an electrically activatable material. The electrically activatable material is a dielectric elastomer.

### CROSS REFERENCE TO RELATED APPLICATIONS

This application claims benefit to German Patent Application No. DE 10 2024 119 015.9, filed on Jul. 4, 2024, which is hereby incorporated by reference herein.

### FIELD

The invention relates to a vehicle cabin assembly having a self-presenting cabin functional part which can be moved from a passive position into an active position in a vehicle cabin using a guiding device combined with an electrically activatable material. The invention further relates to a motor vehicle method having such a vehicle cabin assembly.

### BACKGROUND

The German publication DE 11 2007 002 135 T5 discloses a releasable fastener system having a cavity portion and a button portion combined with an activation apparatus, wherein the button portion is made from a reinforced polymer containing a filler which can comprise a dielectric material. The German patent application DE 10 2008 011 888 A1 discloses a self-presenting apparatus, comprising: An element in physical connection with a surface, wherein the element is configured such that it has a first shape and a second shape, wherein the first shape preserves the element and the second shape presents the element from the surface; and an active material in functional connection with the element, wherein the active material is configured so as to experience a change of at least one characteristic upon receipt of an activation signal, wherein the change in the at least one characteristic is effective in order to transition the element from the first shape to the second shape. The German specification DE 10 2008 053 341 B4 discloses a self-acting apparatus that is connected to a vehicle surface and can take two different shapes, wherein a shape change is enabled by an active material. The German specification DE 10 2008 013 148 B4 discloses a self-presenting grip assembly having an active material comprising an electroactive polymer and having a resetting mechanism and a detent.

### SUMMARY

In an embodiment, the present disclosure provides a vehicle cabin assembly, including a self-presenting cabin functional part configured to be moved from a passive position into an active position in a vehicle cabin using a guiding device combined with an electrically activatable material. The electrically activatable material is a dielectric elastomer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a vehicle cabin assembly having a self-presenting cabin functional part that can be moved between a passive position and an active position using a dielectric elastomer actuator;

FIG. 2 is an example embodiment of the vehicle cabin assembly in which the cabin functional part is configured as a pivotable coat hook;

FIG. 3 is a similar illustration as in FIG. 2, wherein the cabin functional part is configured as a coat hook that can be extended in a translatory manner;

FIG. 4 illustrates a further example embodiment of the vehicle cabin assembly in a schematic diagram, wherein a dielectric elastomer actuator is combined with a guiding device comprising an inner cone and an outer cone, with the cabin functional part in its active position;

FIG. 5 illustrates the same example embodiment as in FIG. 4, with the cabin functional part in its passive position, in which the cabin functional part is reset by a spring device;

FIG. 6 illustrates the same example embodiment as in FIGS. 4 and 5, but without the spring device;

FIG. 7 illustrates a variant of the example embodiment from FIGS. 4 to 6, with a push-push mechanism;

FIG. 8 illustrates a variant of the example embodiment from FIGS. 4 to 7, with a diabolo catch; and

FIG. 9 illustrates a further example embodiment of the vehicle cabin assembly, wherein the cabin functional part is configured as an operating element.

### DETAILED DESCRIPTION

Embodiments of the present invention improve a vehicle cabin assembly in terms of manufacturing technology and/or function.

An embodiment that provides the improvements can include a vehicle cabin assembly having a self-presenting cabin functional part which can be moved from a passive position into an active position in a vehicle cabin using a guiding device combined with an electrically activatable material, in that the electrically activatable material is a dielectric elastomer. The cabin functional part is, for example, a handle, a coat hook, or an operating element, which in its active position performs a desired function in a vehicle cabin of a motor vehicle, and in a preferred embodiment a passenger car. In its passive position, the cabin functional part is preferably not, or only partially, functional. The guiding device for the cabin functional part can comprise a pivoting mechanism, with the help of which the cabin functional part can be pivoted between its passive position and its active position. However, the guiding device can also be designed, for example, in a rail-like or piston-like fashion so as to enable a translatory movement of the cabin functional part between its passive and active positions. The dielectric elastomer in the vehicle cabin assembly advantageously serves to realize a dielectric elastomer actuator. The dielectric elastomer actuator is connected to an electrical power source. By energizing, that is to say by applying an electrical voltage, the dielectric elastomer can be activated in order to move the cabin functional part from its passive position to its active position, or vice versa. Depending on the design of the dielectric elastomer actuator, the cabin functional part can be reversibly moved back and forth between its active and its passive position only with the aid of the dielectric elastomer. However, depending on the design of the dielectric elastomer actuator and/or the cabin functional part, the dielectric elastomer actuator in the vehicle cabin assembly can also be combined with a resetting mechanism and/or a locking mechanism.

A preferred example embodiment of the vehicle cabin assembly is characterized in that the cabin functional part is a coat hook. In its passive position, the coat hook is advantageously not, or barely, visible in the vehicle cabin. In its active position, the coat hook in the vehicle cabin is used in the known manner to hang a garment.

A further preferred example embodiment of the vehicle cabin assembly is characterized in that the cabin functional part is an operating element. The operating element is, for example, an actuating button of an electronic device in the cabin of the motor vehicle. For example, the electronic device is a radio or an infotainment component. The operating element can be actuated by pressing, rotating, or otherwise. The operating element is advantageously actuatable only in its active position and preferably also visible in the cabin of the motor vehicle. In its passive position, the operating element is advantageously not at all, or barely, visible in the cabin of the motor vehicle.

A further preferred example embodiment of the vehicle cabin assembly is characterized in that the guiding device comprises an inner cone that cooperates with an outer cone of the cabin functional part. This design of the guiding device has proven particularly advantageous with regard to the use of the dielectric elastomer in the dielectric elastomer actuator described above.

A further preferred example embodiment of the vehicle cabin assembly is characterized in that the guiding device is combined with a resetting device. The resetting device can be designed in very different ways. For example, the resetting device can comprise a magnetic device. In a simple variant, the biasing device comprises, for example, a spring device. With the aid of the resetting device, the cabin functional part can advantageously be reset from its active position to its passive position.

A further preferred example embodiment of the vehicle cabin assembly is characterized in that the guiding device is combined with a push-push mechanism. The push-push mechanism advantageously comprises a heart curve mechanism, known per se. By combining the push-push mechanism with the dielectric elastomer actuator as described above, a particularly stable operation of the cabin functional part in the vehicle cabin assembly can be ensured.

A further preferred example embodiment of the vehicle cabin assembly is characterized in that the guiding device is combined with a locking device, in particular with a diabolo catch. Thus, in combination with the dielectric elastomer actuator as described above, it can be easily ensured that the cabin functional part is stably held in its passive position.

A further preferred example embodiment of the vehicle cabin assembly is characterized in that the cabin functional part is arranged fully recessed in its passive position in a corresponding receiving space. This has proven to be advantageous for both optical reasons and functional reasons.

A further preferred example embodiment of the vehicle cabin assembly is characterized in that the cabin functional part is covered towards a cabin by an elastically deformable, and in a preferred embodiment opaque, material. The elastically deformable, and in the preferred embodiment opaque, material is designed such that the cabin functional part is not visibly arranged in the vehicle cabin in its passive position. Upon activation of the cabin functional part by the dielectric elastomer actuator, the material enables the desired function of the cabin functional part. For example, the material can comprise at least one opening for extending the coat hook when designing the cabin functional part as a coat hook. The combination with the elastically deformable, and in the preferred embodiment opaque, material is particularly advantageous in the design of the cabin functional part as an operating element.

A further preferred example embodiment of the vehicle cabin assembly is characterized in that the cabin functional part is combined with a proximity sensor that activates the dielectric elastomer upon approaching a human body part. This can improve operator comfort in the vehicle cabin. The proximity sensor preferably operates on a capacitive basis. The proximity sensor can be attached to the cabin functional part itself. However, the proximity sensor can also be arranged only in proximity to the cabin functional part.

Embodiments of the present invention further relate to a cabin functional part, a guiding device, an inner cone, an outer cone, a resetting device, a push-push mechanism, a diabolo catch, and/or a proximity sensor for a vehicle cabin assembly as described above. The aforementioned parts can be purchased separately.

Embodiments of the present invention further relate to a motor vehicle with a vehicle cabin assembly as described above.

Further advantages, features, and details of the invention arise from the following description, in which various embodiments of the invention are described in detail with reference to the drawings.

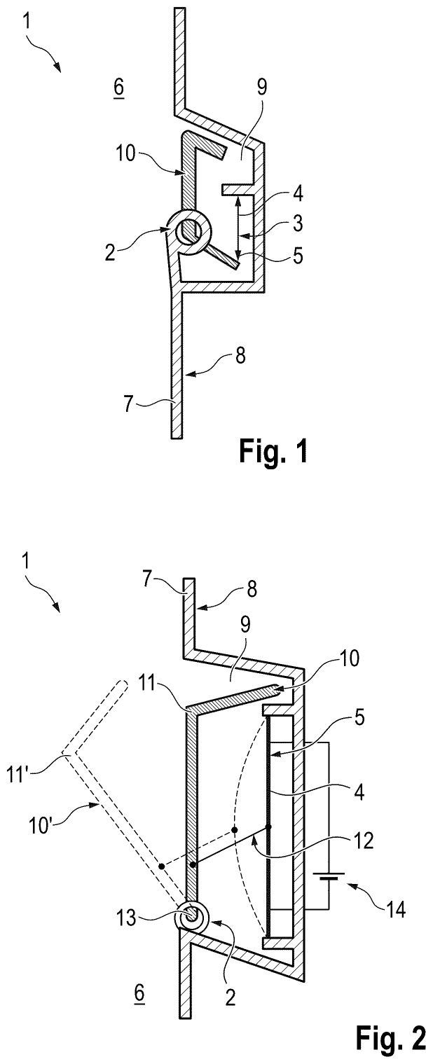

Various example embodiments of a vehicle cabin assembly 1 of a motor vehicle are shown in FIGS. 1 to 9. For example, the motor vehicle is a passenger vehicle with a vehicle cabin 6. The vehicle cabin 6 is designed as, or is similar to, conventional motor vehicles.

The vehicle cabin assembly 1 is configured as a coat hook 11, for example, or as an operating element 19. However, different from what is shown, the cabin functional part 10 can also be arranged as a handle in the cabin of the motor vehicle, for example. The cabin functional part 10 that the cabin functional part 10 can be moved between a passive position and an active position using a dielectric elastomer actuator 5.

In its passive position, the cabin functional part 10 is arranged in a receiving space 9, which is provided for this purpose in a cabin surface 7 of the motor vehicle. The cabin surface 7 is bounded towards the vehicle cabin 6 by a cabin panel 8. The cabin panel 8 is attached to a support structure of the motor vehicle.

An electrically activatable material 3 is used in order to activate and/or passivate the cabin functional part 10. The electrically activatable material 3 is a dielectric elastomer 4 integrated in a dielectric elastomer actuator 5. The dielectric elastomer actuator 5 is integrated in the receiving space 9 in the vehicle cabin assembly 1 such that the dielectric elastomer actuator 5 cannot be seen from the vehicle cabin 6.

The dielectric elastomer actuator 5 is combined in the vehicle cabin assembly 1 with a guiding device 2. The guiding device 2 serves to realize defined movements of the cabin functional part 10 when the cabin functional part 10 is moved between its passive position and its active position with the aid of the dielectric elastomer actuator 5 upon activation and/or passivation thereof.

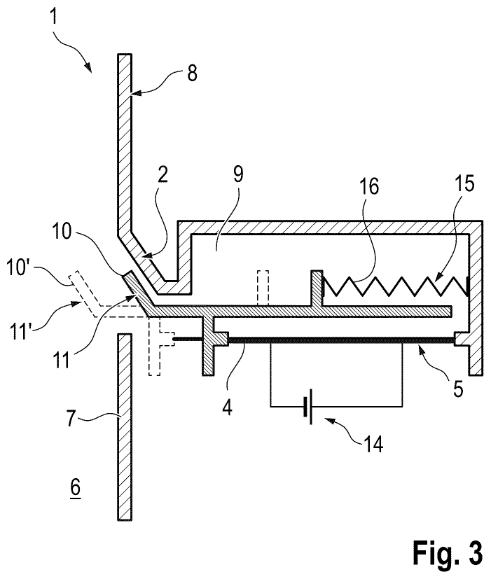

In FIGS. 1, 5, 6 and 9, the cabin functional part 10 is shown in its passive position. In FIGS. 2 and 3, the cabin functional part is indicated in both its passive position 10 and its active position 10′. In FIG. 2, the cabin functional part 10, 10′ can be pivoted by the guiding device 2 between the passive and the active position about a pivot axis 13. In FIG. 3, the cabin functional part 10, 10′ can be inserted and extended in a translatory manner by the guiding device 2.

In FIG. 2, the cabin functional part 10, 10′ configured as a coat hook 11, 11′ is coupled to the dielectric elastomer actuator 5 by a coupling element 12. The dielectric elastomer 4 of the dielectric elastomer actuator 5 can be subjected to a voltage for activation or passivation, as indicated in FIGS. 2 to 9 by a symbol of a power source 14.

In FIG. 1, the dielectric elastomer actuator 5 is indicated only by a double arrow. For example, the dielectric elastomer actuator 5 consists of a plurality of layers of the dielectric elastomer 4. By applying an electrical voltage, the dielectric elastomer 4 in the dielectric elastomer actuator 5 is purposefully deformed so as to activate or passivate the cabin functional part 10.

Depending on the design of the dielectric elastomer actuator 5, a desired activation movement or passivation movement of the cabin functional part 10 is realized using the dielectric elastomer actuator 5. As soon as the voltage applied on the dielectric elastomer actuator 5 via the power source 14 is interrupted, the dielectric elastomer actuator 5 regains its original form. This results in the activation movement or passivation movement being reset.

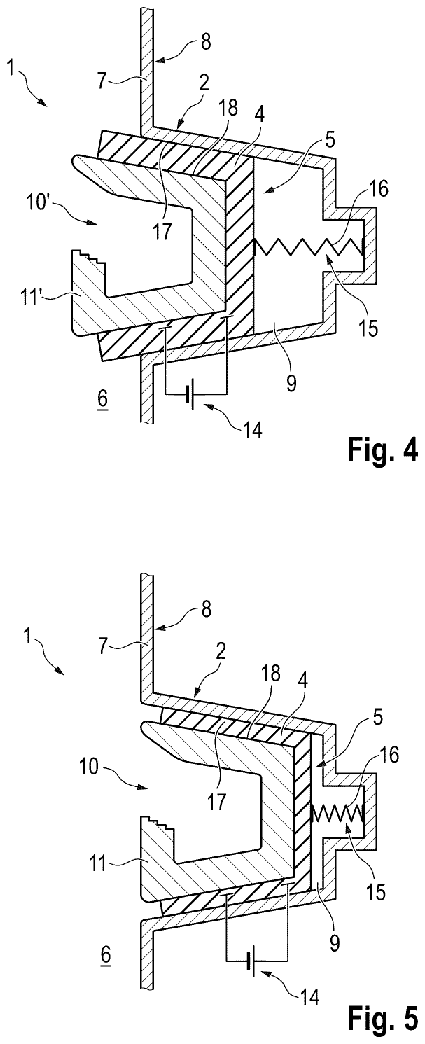

The resetting movement for passivating the cabin functional part 10 can be supported by a spring device 15 shown in FIGS. 4 and 5. The spring device 15 is indicated by a spring symbol. The spring device 15 can be realized in a variety of ways, for example, also by a magnetic device or by an elastically deformable foam.

The spring device 15 can therefore also generally be referred to as a resetting device 16. Depending on the design of the dielectric elastomer actuator 5 in combination with the guiding device 2, the resetting device 16 can also be omitted. The resetting device 16 can also be shown with an additional dielectric elastomer actuator 5 according to a further example embodiment.

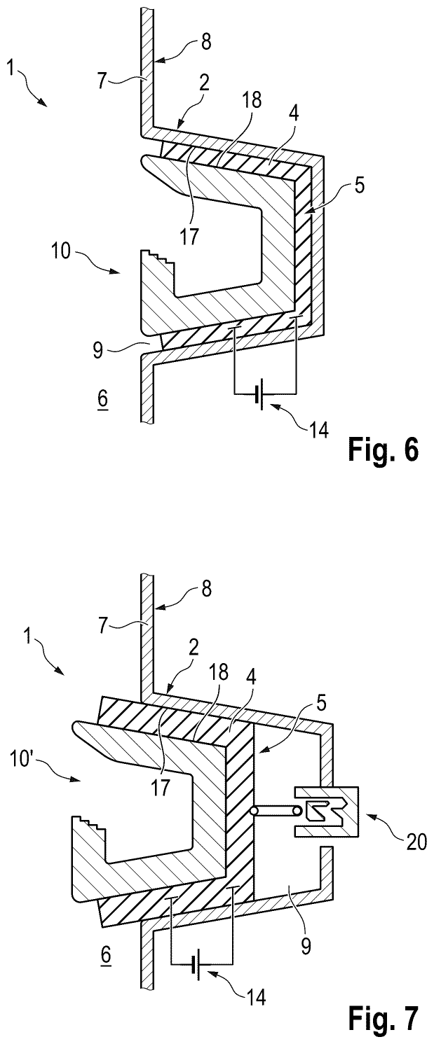

In the example embodiment shown in FIG. 6, the resetting movement is caused without a spring device, that is to say solely by the dielectric elastomer actuator 5. In FIGS. 4 to 9, the guiding device 2 combined with the dielectric elastomer actuator 5 comprises an inner cone 17 that cooperates with an outer cone 18 in order to realize the desired activation movement and/or passivation movement of the cabin functional part 10 in combination with the dielectric elastomer 4 of the dielectric elastomer actuator 5 arranged therebetween.

The inner cone 17 is configured in the receiving space 9. The outer cone 18 is configured on the cabin functional part 10. Between the inner cone 17 and the outer cone 18, the dielectric elastomer 4 of the dielectric elastomer actuator 5 is arranged.

When the dielectric elastomer 4 of the dielectric elastomer actuator 5 expands between the inner cone 17 and the outer cone 18, the cabin functional part 10 is pushed out of the receiving space 9. When the dielectric elastomer 4 of the dielectric elastomer actuator 5 contracts again, the cabin functional part 10 is reset.

When a voltage is applied, the dielectric elastomer 4 expands between the inner cone 17 and the outer cone 18. This pushes the cabin functional part 10 out of the receiving space 9. If the voltage is removed, the dielectric elastomer 4 retracts between the inner cone 17 and the outer cone 18. To realize the resetting movement, it can be advantageous to glue the dielectric elastomer 4 of the dielectric elastomer actuator 5 to, for example, the bottom of the receiving space 9.

FIG. 7 shows an example embodiment in which the dielectric elastomer actuator 5 is combined with a push-push mechanism 20. By means of push-push mechanism 20, it can be achieved that, upon a first activation, the cabin functional part 10 is activated by the dielectric elastomer actuator 5, whereas the cabin functional part 10 is passivated upon a second activation of the dielectric elastomer actuator 5.

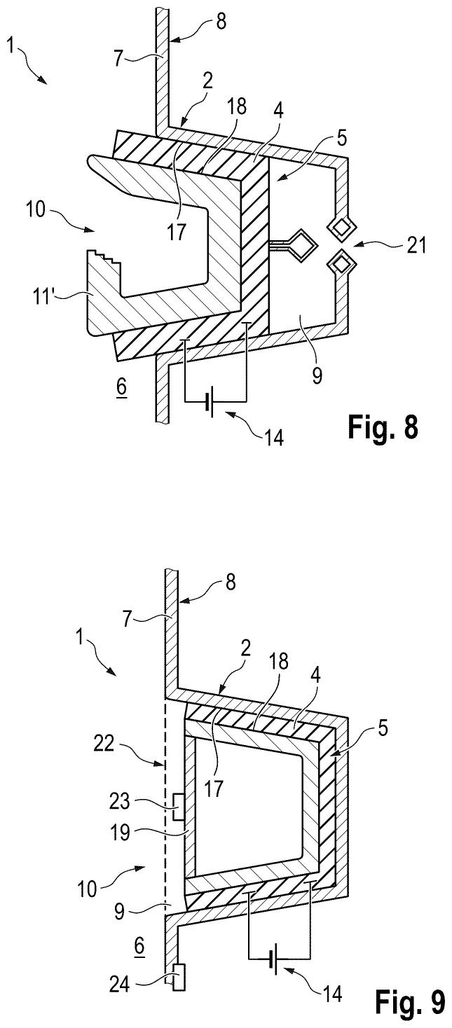

In FIG. 8, the dielectric elastomer actuator 5 is combined with a diabolo catch 21. The diabolo catch 21 advantageously serves to keep the cabin functional part 10 defined in its passive state.

In FIG. 9 it is indicated in a strongly simplified manner that the cabin functional part 10, which is configured as the operating element 19, can advantageously be combined with at least one proximity sensor 23, 24. The proximity sensor 23 is provided in a surface of the operating element 19 facing the vehicle cabin 6. The proximity sensor 24 is arranged in the vicinity of the fully recessed passivated operating element 19 in the receiving space 9.

In the passive position shown in FIG. 9, the operating element 19 is arranged entirely in the receiving space 9. A plastically deformable material 22 is indicated by a dashed line, which covers the operating element 19 in its passive position in the receiving space 9 towards the vehicle cabin 6.

When activated by the dielectric elastomer actuator 5, the operating element 19 is moved out of the receiving space 9. The plastically deformable material 22 then abuts the operating element 19. The activation and extension of the operating element 19 are advantageously automatically triggered when a body part, for example a finger, of a person in the vehicle cabin 6 approaches at least one of the proximity sensors 23, 24.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMBERS

1 Vehicle cabin assembly
2 Guiding device
3 Electrically activatable material
4 Dielectric elastomer
5 Dielectric elastomer actuator
6 Vehicle cabin
7 Cabin surface
8 Cabin panel
9 Receiving space
10 Cabin functional part
11 Coat hook
12 Coupling element
13 Pivot axis
14 Power source
15 Spring device
16 Resetting device
17 Inner cone
18 Outer cone
19 Operating element
20 Push-push mechanism
21 Diabolo catch
22 Plastic-deformable material
23 Proximity sensor
24 Proximity sensor

1. A vehicle cabin assembly, comprising a self-presenting cabin functional part configured to be moved from a passive position into an active position in a vehicle cabin using a guiding device combined with an electrically activatable material, wherein the electrically activatable material is a dielectric elastomer.

2. The vehicle cabin assembly according to claim 1, wherein the cabin functional part is a coat hook.

3. The vehicle cabin assembly according to claim 1, wherein the cabin functional part is an operating element.

4. The vehicle cabin assembly according to claim 1, wherein the guiding device comprises an inner cone that cooperates with an outer cone of the cabin functional part.

5. The vehicle cabin assembly according to claim 1, wherein the guiding device is further combined with a resetting device.

6. The vehicle cabin assembly according to claim 1, wherein the guiding device is further combined with a push-push mechanism.

7. The vehicle cabin assembly according to claim 1, wherein the guiding device is further combined with a locking device.

8. The vehicle cabin assembly according to claim 1, wherein the cabin functional part is arranged fully recessed in the passive position in a corresponding receiving space.

9. The vehicle cabin assembly according to claim 1, wherein the cabin functional part is covered towards a cabin by an elastically deformable material.

10. The vehicle cabin assembly according to claim 1, wherein the cabin functional part is further combined with a proximity sensor that activates the dielectric elastomer upon approaching a human body part.

11. A system, comprising: the cabin functional part, the guiding device, an inner cone, an outer cone, a resetting device, a push-push mechanism, a diabolo catch, and/or a proximity sensor for a vehicle cabin assembly according to claim 1.

12. A motor vehicle comprising a vehicle cabin assembly according to claim 1.

13. The vehicle cabin assembly according to claim 7, wherein the locking device is a diabolo catch.

14. The vehicle cabin assembly according to claim 9, wherein the elastically deformable material is an opaque material.
